(19) United States
(12) Patent Application Publication
(10) Pub. No.: US 2025/0136367 A1
(43) Pub. Date: May 1, 2025

(54) REFUSE VEHICLE WITH PRIORITY ORDER CAMERAS

(71) Applicant: Oshkosh Corporation, Oshkosh, WI (US)

(72) Inventors: Vince Schad, Oshkosh, WI (US); Andy Cornelius, Oshkosh, WI (US); Nick Weykamp, Oshkosh, WI (US); Quincy Wittman, Oshkosh, WI (US); Jerrod Kappers, Oshkosh, WI (US); Brendan Chan, Oshkosh, WI (US); Eric Olson, Oshkosh, WI (US); Zhenyi Wei, Oshkosh, WI (US); Alec Ehlke, Oshkosh, WI (US); Jeff Meyer, Oshkosh, WI (US); Umang Patel, Oshkosh, WI (US); Austin Mahoney, Oshkosh, WI (US); Thomas Vale, Oshkosh, WI (US); William Young, Oshkosh, WI (US); Nagabhushana Sharma Gurumurthy, Oshkosh, WI (US); Johnny Bui, Oshkosh, WI (US)

(73) Assignee: Oshkosh Corporation, Oshkosh, WI (US)

(21) Appl. No.: 18/917,684

(22) Filed: Oct. 16, 2024

Related U.S. Application Data
(60) Provisional application No. 63/593,791, filed on Oct. 27, 2023.

(51) Int. Cl. B65F 3/02; H04N 7/18; H04N 23/90

(52) U.S. Cl. CPC B65F 3/02; H04N 7/181; H04N 23/90

(57) ABSTRACT

A refuse vehicle includes a chassis, a body coupled to the chassis and defining a refuse compartment, a lift assembly configured to lift a refuse container to dump contents thereof into the refuse compartment, a display interface, a plurality of cameras positioned to capture a plurality of different views from the refuse vehicle, and a controller. The controller is configured to assign priority values to the plurality of different views, compare the priority values, and display, on the display interface, at least one of the plurality of different views based on the comparison of the priority values.

### CROSS-REFERENCE TO RELATED PATENT APPLICATION

This application claims the benefit of and priority to U.S. Provisional Patent Application No. 63/593,791, filed Oct. 27, 2023, which is incorporated herein by reference in its entirety.

### BACKGROUND

The present disclosure generally relates to the field of refuse vehicles. More specifically, the present disclosure relates to control systems for refuse vehicles that include cameras configured to automatically, autonomously, or semi-autonomously capture images of a region of interest around the refuse vehicle and prioritize how such images are displayed.

### SUMMARY

One embodiment relates to a refuse vehicle. The refuse vehicle includes a chassis, a body coupled to the chassis and defining a refuse compartment, a lift assembly configured to lift a refuse container to dump contents thereof into the refuse compartment, a display interface, a plurality of cameras positioned to capture a plurality of different views from the refuse vehicle, and a controller. The controller is configured to assign priority values to the plurality of different views, compare the priority values, and display, on the display interface, at least one of the plurality of different views based on the comparison of the priority values.

Another embodiment of relates to a refuse vehicle. The refuse vehicle includes a chassis, a body coupled to the chassis and having a refuse compartment with a hopper area, a lift assembly configured to lift a refuse container to dump contents thereof into the hopper area, a display interface, a lift assembly camera positioned to capture a first view of an area proximate the lift assembly, a hopper camera positioned to capture a third view of the hopper, and a controller. The controller is configured to detect at least one of a refuse container proximate the refuse vehicle or operation of the lift assembly, control the display interface to display the first view, determine that the lift assembly has lifted the refuse container to a position threshold, and control the display interface to transition from displaying the first view to displaying at least the second view in response to the position threshold being reached.

Still another embodiment relates to a refuse vehicle system. The refuse vehicle system includes a lift assembly camera configured to positioned to capture a first view of a lift area proximate a lift assembly of a refuse vehicle, a hopper camera configured to be positioned to capture a second view of a hopper area of the refuse vehicle, and a non-transitory computer-readable medium having instructions stored thereon. The instructions, when executed by one or more processors, cause the one or more processors to detect at least one of a refuse container proximate the refuse vehicle or operation of the lift assembly, control a display interface of the refuse vehicle to display the first view, determine that the lift assembly has lifted the refuse container to a position threshold; and control the display interface to transition from displaying the first view to displaying at least the second view in response to the position threshold being reached.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a front-loading refuse vehicle, according to an exemplary embodiment.

FIG. 2 is a side view of a rear-loading refuse vehicle, according to an exemplary embodiment.

FIG. 3 is a perspective view of a side-loading refuse vehicle, according to an exemplary embodiment.

FIG. 4 is an example block diagram of a control system for any of the refuse vehicles of FIGS. 1-3 equipped with a camera selection system, according to an exemplary embodiment.

FIG. 5 is a diagram illustrating a collection route for autonomous transport and collection by any of the refuse vehicles of FIGS. 1-3, according to an exemplary embodiment;

FIG. 6 is a side perspective view of a multiple backup camera system of any of the refuse vehicles of FIGS. 1-3, according to an exemplary embodiment.

FIG. 7 is a flow chart illustrating an example method of operation for a multiple backup camera system of any of the refuse vehicles of FIGS. 1-3.

FIG. 8 is a side perspective view of a multiple backup camera system of any of the refuse vehicles of FIGS. 1-3 showing both a tailgate in a fully open position and a closed position, according to an exemplary embodiment.

FIG. 9 is a side perspective view of a multiple backup camera system of any of the refuse vehicles of FIGS. 1-3 showing a tailgate in a partially open position, according to an exemplary embodiment.

FIG. 10 is a side perspective view of a multiple backup camera system of any of the refuse vehicles of FIGS. 1-3 showing a tailgate in a partially open position, according to another exemplary embodiment.

FIG. 11 is a top perspective view of a refuse vehicle equipped with a camera selection system, according to an exemplary embodiment.

FIG. 12 is an example perspective view from an arm/side camera system, according to an exemplary embodiment.

FIG. 13 is an example perspective view from a hopper camera system, according to an exemplary embodiment.

FIG. 14 is an illustrative GUI of a refuse vehicle equipped with a camera selection system showing an example view from an arm/side camera system, according to an exemplary embodiment.

FIG. 15 is the illustrative GUI of FIG. 14, showing an example view from an arm/side camera system and a hopper camera system, according to an exemplary embodiment.

FIG. 16 is the illustrative GUI of FIG. 14, showing an example view from a multiple backup camera system and an arm/side camera system, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Referring generally to the FIGURES, a refuse vehicle can include a camera selection system interoperable with one or more camera systems. For example, the camera selection system may be interoperable with a multiple camera backup system, an arm/side camera system, a hopper camera system, etc. The camera selection system may be communicatively coupled to a user interface or a display (e.g., a GUI) and may display one or more views from one or more of the camera systems of the refuse vehicle. Further, a controller of the camera selection system may autonomously or semi-autonomously prioritize and select a camera system and/or camera view to display to a user of the refuse vehicle based on a current operation/action of the user and/or events occurring at or near the refuse vehicle. For example, in response to receiving an input at a joystick/controller of a collection arm, the camera selection system may automatically display an arm/side view from the arm/side camera system to assist the operator without requiring operator input. Further, the camera selection system may automatically prioritize, increase the size of, or otherwise toggle the displayed views in response to various operating conditions and/or events associated with the refuse vehicle such as operating in a reverse mode or detecting the presence of an approaching vehicle.

As an illustrative example, the camera selection system may be programmed to prioritize a backup camera view over the other camera system views when the camera selection system detects a reverse operation of the refuse vehicle (e.g., the backup camera view may be displayed as the largest view, the only view, etc., even if collection arm or hopper of the refuse vehicle is in use). The multiple camera backup system may include at least a first and second camera coupled to a tailgate of the refuse vehicle. The system also includes a controller that communicates with the cameras and detects a reverse operation of the refuse vehicle. During the reverse operation, the first camera captures a first image when the tailgate is in a closed position, and the second camera captures a second image when the tailgate is in a fully open position. The first and second cameras capture first and second images when the tailgate is in a partially open position. A third image is generated from the first and second images and may maintain a fixed view as the tailgate opens or closes.

In this way, the camera selection system may autonomously or semi-autonomously select and display a target view (e.g., stitched image, true camera view) from the multiple backup camera system to assist the operator while driving the refuse vehicle by consistently providing an image of areas otherwise obscured from the operator's view (e.g., blind spots, space directly behind the vehicle, etc.). Specifically, while reversing the refuse vehicle, the multiple backup camera system may beneficially allow an operator to navigate with vision of the surroundings behind the vehicle to avoid obstacles, irrespective of the position of the tailgate. For example, systems having only one backup camera located on a tailgate may lose vision or coverage of an area behind the vehicle when the tailgate changes positions. Specifically, a backup camera may be focused on a target area showing the reverse path of a vehicle while a tailgate is closed, but when the tailgate is open, the camera may be directed upwards and above the vehicle such that its field of view no longer provides a useful image showing an operator the reverse path of the vehicle. Further, systems with multiple cameras may provide varied, moving, or inconsistent views rather than a uniform viewpoint behind the vehicle. For example, a system that switches between one angle and another or a system that simultaneously displays two views may cause an operator to miss an obstacle and cause damage to equipment or personnel. Accordingly, the disclosure herein beneficially provides a multiple backup camera system that maintains a focused view of a region behind a refuse vehicle (e.g., such as a region within the backup path of the refuse vehicle) consistently during a reverse operation and regardless of the position of the tailgate.

Further, by utilizing image stitching processes and the like, the disclosure beneficially provides a camera selection system that maintains a fixed viewpoint and accounts for distortion or translation caused by varying angles of images captured by multiple cameras. Additionally, the camera selection system beneficially prioritizes the display of various camera views and/or images from various camera systems responsive to operating conditions of the vehicle and/or events associated with the vehicle. In this way, the camera selection system determines one or more target views from a plurality of views, assigns the target views a priority value, and determines which target views to display and/or the relative size of the target views based on each priority value. Beneficially, the camera selection system disclosed herein may autonomously or semi-autonomously anticipate an operator's needs and/or which camera system view would be most beneficial to display and selectively display the views of the respective camera systems.

### Refuse Vehicle

### Front-Loading Configuration

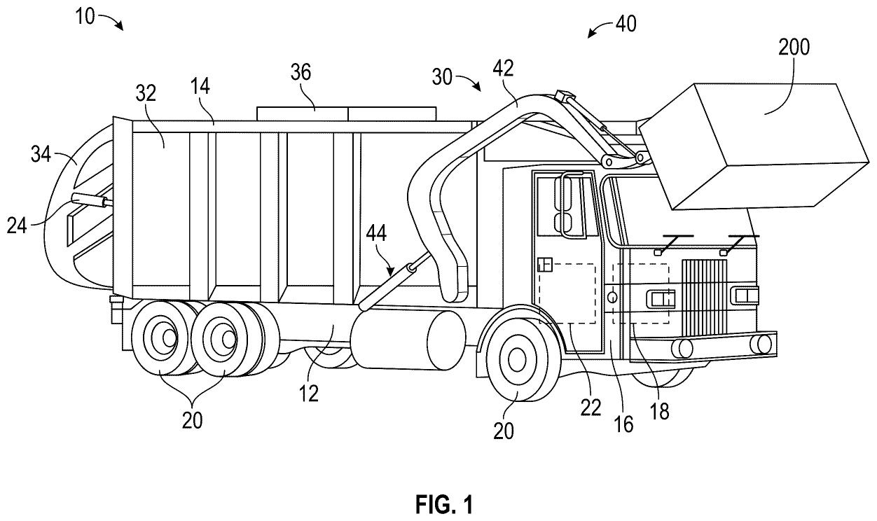

Referring to FIG. 1, a vehicle, shown as refuse vehicle 10 (e.g., a garbage truck, a waste collection truck, a sanitation truck, etc.), is shown that is configured to collect and store refuse along a collection route. In the embodiment of FIG. 1, the refuse vehicle 10 is configured as a front-loading refuse vehicle. The refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In yet other embodiments, the storage volume is positioned between the hopper volume and the cab 16 (e.g., a rear-loading refuse vehicle, etc.).

The tailgate 34 may be hingedly or pivotally coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotally coupled with the frame 12 such that the refuse compartment 30 can be driven to raise or lower while the tailgate 34 is open in order to dump contents of the refuse compartment 30 at a landfill. The refuse compartment 30 may include a packer assembly (e.g., a compaction apparatus) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to frame 12 with a pivot (e.g., a lug, a shaft, etc.). The lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment. Lift arms 42 may be removably coupled to a container, shown as refuse container 200 in FIG. 1. Lift arms 42 are configured to be driven to pivot by lift arm actuators 44 to lift and empty the refuse container 200 into the hopper volume for compaction and storage. The lift arms 42 may be coupled with a pair of forks or elongated members that are configured to removably couple with the refuse container 200 so that the refuse container 200 can be lifted and emptied. The refuse container 200 may be similar to the container attachment 200 as described in greater detail in U.S. application Ser. No. 17/558,183, filed Dec. 12, 2021, the entire disclosure of which is incorporated by reference herein.

### Rear-Loading Configuration

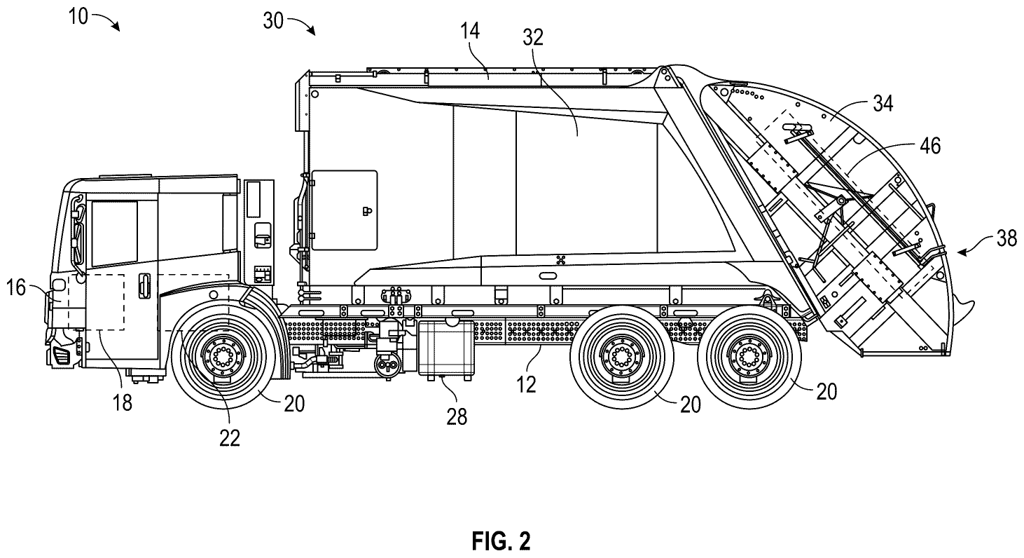

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

### Side-Loading Configuration

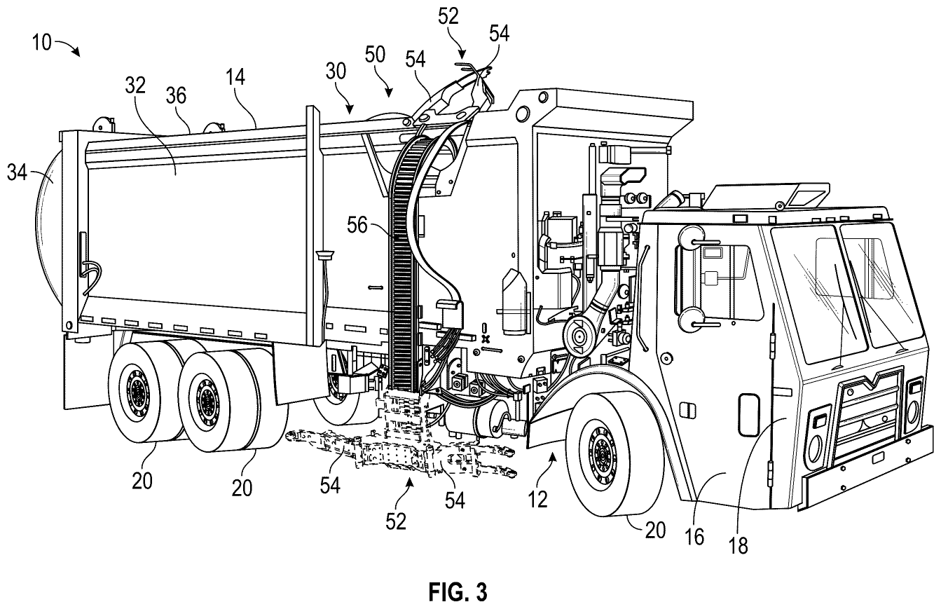

Referring to FIG. 3, the refuse vehicle 10 may be configured as a side-loading refuse vehicle (e.g., a zero radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56, and return the refuse container to the ground. Once the refuse container has been placed on the ground, the grabber assembly may transition into the disengaged state, releasing the refuse container.

### Control System

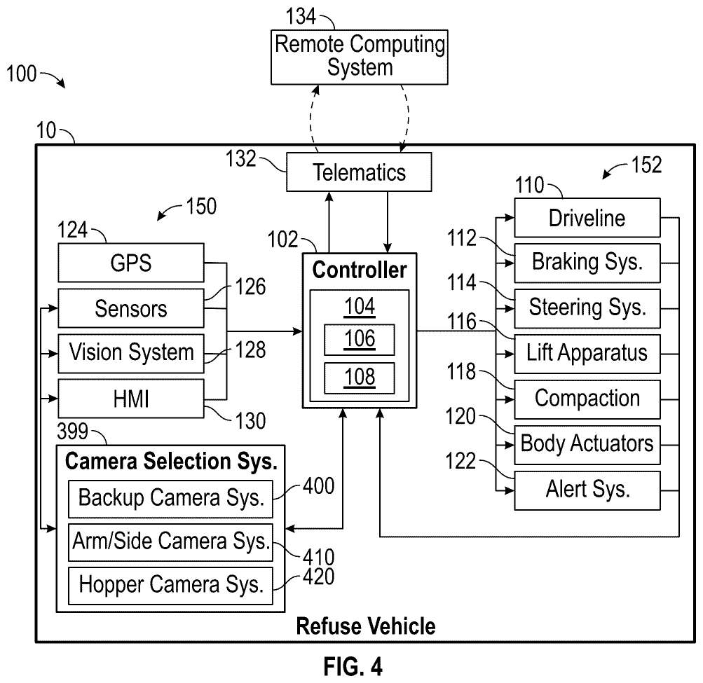

Referring to FIG. 4, the refuse vehicle 10 may include a control system 100 that is configured to facilitate autonomous or semi-autonomous operation of the refuse vehicle 10, or components thereof. The control system 100 includes a controller 102 that is positioned on the refuse vehicle 10, a remote computing system 134, a telematics unit 132, one or more input devices 150, and one or more controllable elements 152. The input devices 150 can include a Global Positioning System (“GPS”), multiple sensors 126, a vision system 128 (e.g., an awareness system), and a Human Machine Interface (“HMI”). The controllable elements 152 can include a driveline 110 of the refuse vehicle 10, a braking system 112 of the refuse vehicle 10, a steering system 114 of the refuse vehicle 10, a lift apparatus 116 (e.g., the lift assembly 40, the lift assembly 50, etc.), a compaction system 118 (e.g., a packer assembly, the packer 46, etc.), body actuators 120 (e.g., tailgate actuators 24, lift or dumping actuators, etc.), and/or an alert system 122.

The controller 102 includes processing circuitry 104 including a processor 106 and memory 108. Processing circuitry 104 can be communicably connected with a communications interface of controller 102 such that processing circuitry 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via processing circuitry 104 and includes computer code for executing (e.g., by at least one of processing circuitry 104 or processor 106) one or more processes described herein.

The controller 102 is configured to receive inputs (e.g., measurements, detections, signals, sensor data, etc.) from the input devices 150, according to some embodiments. In particular, the controller 102 may receive a GPS location from the GPS system 124 (e.g., current latitude and longitude of the refuse vehicle 10). The controller 102 may receive sensor data (e.g., engine temperature, fuel levels, transmission control unit feedback, engine control unit feedback, speed of the refuse vehicle 10, etc.) from the sensors 126. The controller 102 may receive image data (e.g., real-time camera data, 360 degree camera data) from the vision system 128 of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 16 of the refuse vehicle 10, etc.). The controller 102 may receive user inputs from the HMI 130 (e.g., button presses, requests to perform a lifting or loading operation, driving operations, steering operations, braking operations, etc.).

The controller 102 may be configured to provide control outputs (e.g., control decisions, control signals, etc.) to the driveline 110 (e.g., the engine 18, the transmission 22, the engine control unit, the transmission control unit, etc.) to operate the driveline 110 to transport the refuse vehicle 10. The controller 102 may also be configured to provide control outputs to the braking system 112 to activate and operate the braking system 112 to decelerate the refuse vehicle 10 (e.g., by activating a friction brake system, a regenerative braking system, etc.). The controller 102 may be configured to provide control outputs to the steering system 114 to operate the steering system 114 to rotate or turn at least two of the tractive elements 20 to steer the refuse vehicle 10. The controller 102 may also be configured to operate actuators or motors of the lift apparatus 116 (e.g., lift arm actuators 44) to perform a lifting operation (e.g., to grasp, lift, empty, and return a refuse container). The controller 102 may also be configured to operate the compaction system 118 to compact or pack refuse that is within the refuse compartment 30. The controller 102 may also be configured to operate the body actuators 120 to implement a dumping operation of refuse from the refuse compartment 30 (e.g., driving the refuse compartment 30 to rotate to dump refuse at a landfill). The controller 102 may also be configured to operate the alert system 122 (e.g., lights, speakers, display screens, etc.) to provide one or more aural or visual alerts to nearby individuals.

The controller 102 may also be configured to receive feedback from any of the driveline 110, the braking system 112, the steering system 114, the lift apparatus 116, the compaction system 118, the body actuators 120, or the alert system 122. The controller may provide any of the feedback to the remote computing system 134 via the telematics unit 132. The telematics unit 132 may include any wireless transceiver, cellular dongle, communications radios, antennas, etc., to establish wireless communication with the remote computing system 134. The telematics unit 132 may facilitate communications with telematics units 132 of nearby refuse vehicles 10 to thereby establish a mesh network of refuse vehicles 10.

The controller 102 is configured to use any of the inputs from any of the GPS 124, the sensors 126, the vision system 128, or the HMI 130 to generate controls for the driveline 110, the braking system 112, the steering system 114, the lift apparatus 116, the compaction system 118, the body actuators 120, or the alert system 122. In some embodiments, the controller 102 is configured to operate the driveline 110, the braking system 112, the steering system 114, the lift apparatus 116, the compaction system 118, the body actuators 120, and/or the alert system 122 to autonomously transport the refuse vehicle 10 along a route (e.g., self-driving), perform pickups or refuse collection operations autonomously, and transport to a landfill to empty contents of the refuse compartment 30. The controller 102 may receive one or more inputs from the remote computing system 134 such as route data, indications of pickup locations along the route, route updates, customer information, pickup types, etc. The controller 102 may use the inputs from the remote computing system 134 to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the remote computing system 134 is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 134 may perform any of the route planning techniques as described in greater detail in U.S. application Ser. No. 18/111,137, filed Feb. 17, 2023, the entire disclosure of which is incorporated by reference herein. The remote computing system 134 may implement any route planning techniques based on data received by the controller 102. In some embodiments, the controller 102 is configured to implement any of the cart alignment techniques as described in U.S. application Ser. No. 18/242,224, filed Sep. 5, 2023, the entire disclosure of which is incorporated by reference herein. The refuse vehicle 10 and the remote computing system 134 may also operate or implement geofences as described in greater detail in U.S. application Ser. No. 17/232,855, filed Apr. 16, 2021, the entire disclosure of which is incorporated by reference herein.

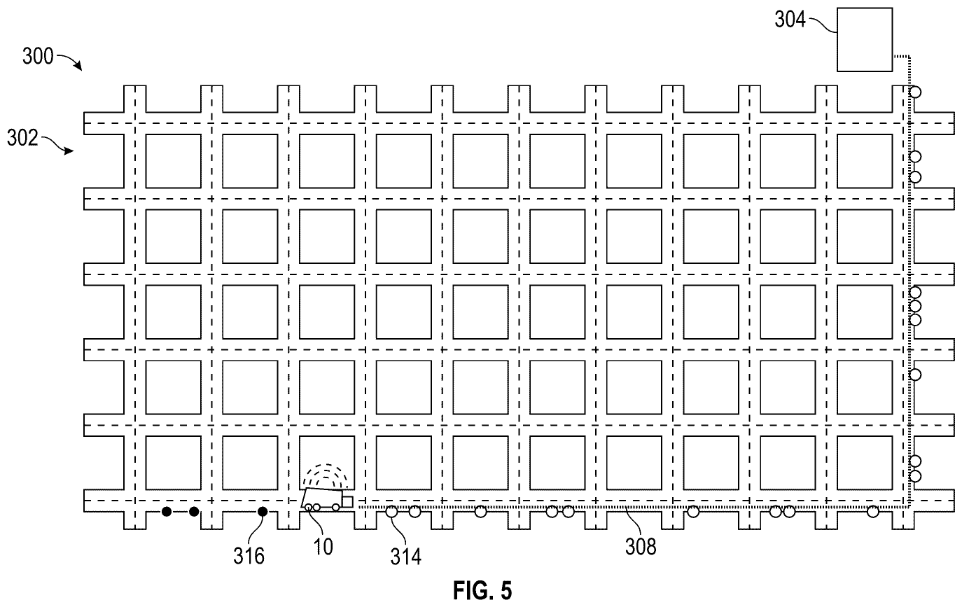

Referring to FIG. 5, a diagram 300 illustrates a route 308 through a neighborhood 302 for the refuse vehicle 10. The route 308 includes future stops 314 along the route 308 to be completed, and past stops 316 that have already been completed. The route 308 may be defined and provided by the remote computing system 134. The remote computing system 134 may also define or determine the future stops 314 and the past stops 316 along the route 308 and provide data regarding the geographic location of the future stops 314 and the past stops 316 to the controller 102 of the refuse vehicle 10. The refuse vehicle 10 may use the route data and the stops data to autonomously transport along the route 308 and perform refuse collection at each stop. The route 308 may end at a landfill 304 (e.g., an end location) where the refuse vehicle 10 may autonomously empty collected refuse, transport to a refueling location if necessary, and begin a new route.

### Camera Selection System

Referring to FIG. 4, the refuse vehicle 10 includes a camera selection system 399 communicatively coupled and/or comprising one or more of a backup camera system 400, an arm/side camera system 410, and a hopper camera system 420. The controller 102 may be configured to operate or otherwise communicate with the camera selection system 399 and components thereof. In other embodiments, the camera selection system 399 may comprise a separate controller and/or components of the controller 102. The camera selection system 399 may also be communicatively coupled to and/or configured to display one or more camera views, video feeds, or the like to a display of the refuse vehicle 10 (e.g., an LCD display of the HMI 130, a screen of a mobile device or tablet in communication with the refuse vehicle 10, etc.). The camera selection system 399 may also be configured to autonomously or semi-autonomously assign priority values to one or more camera views based on operating conditions of the refuse vehicle 10 and/or events associated with the refuse vehicle 10, select a camera view, video feed, or the like to display to an operator based on the assigned priority values.

For example, upon receiving a signal indicating that the refuse vehicle 10 is in a reverse operation, the camera selection system 399 may assign a high priority value to a view from the backup camera system 400. The camera selection system 399 may then compare the priority values to other camera views, select the backup camera view, and display a view of only the backup camera system 400 based on the comparison of the priority values. In another example, upon receiving a signal indicating that the lift apparatus 116 is motion and the refuse vehicle 10 is in a reverse operation, the camera selection system 399 may assign update a view from the arm/side camera system from a low priority value to a higher priority value. Accordingly, the camera selection system may compare the updated priority value to the priority values of other camera views and display both a view from the backup camera system 400 and a view from the arm/side camera system 410. The camera selection system 399 may further prioritize/give preference to one system view over another (e.g., may display the backup camera view larger than the arm/side camera view, may focus on a select portion of one camera view, etc.).

The camera selection system 399 may assign priority values in a number of manners.

For example, the camera selection system 399 may include a lookup table of corresponding events and/or refuse vehicle operating modes that are associated with target cameras views. Such a table may, as an example, correlate a reverse operation to a backup camera view and assign the backup camera view a high priority value. Similarly, the table may correlate a forward drive operation to a backup camera view with a low or no priority value. In other embodiments, a hierarchy of target camera views and respective triggering conditions may be predetermined or programmed into the memory 108 of the controller 102 of the camera selection system 399. A respective tier on the hierarchy may represent a priority value and views ranked higher may be displayed preferentially over views ranked lower (e.g., a view from the hopper camera system 420 while the lift apparatus 116 is at a full raise position may be ranked higher and given preference over a view from the backup camera system 400 while the refuse vehicle is in a forward drive or park mode). In still further embodiments, the camera selection system 399 may utilize algorithms, predictive logic, AI/machine learning models, or other heuristics to assign priority to target views from various camera systems.

The backup camera system 400 may be configured to capture an image showing the area proximate to the rear of the refuse vehicle 10. The backup camera system 400 is configured to maintain the image of the area proximate to the rear of the refuse vehicle 10 irrespective of the position of the tailgate 34. For example, while in a reverse operation, an image of the area behind the refuse vehicle 10 may be generated and presented to an operator. The tailgate 34 of the refuse vehicle 10 may open or close during the reverse operation. However, the backup camera system 400 continues to display the image of the area behind the refuse vehicle 10 regardless of the position of the tailgate 34 by selectively capturing images via a plurality of cameras of the vision system 128.

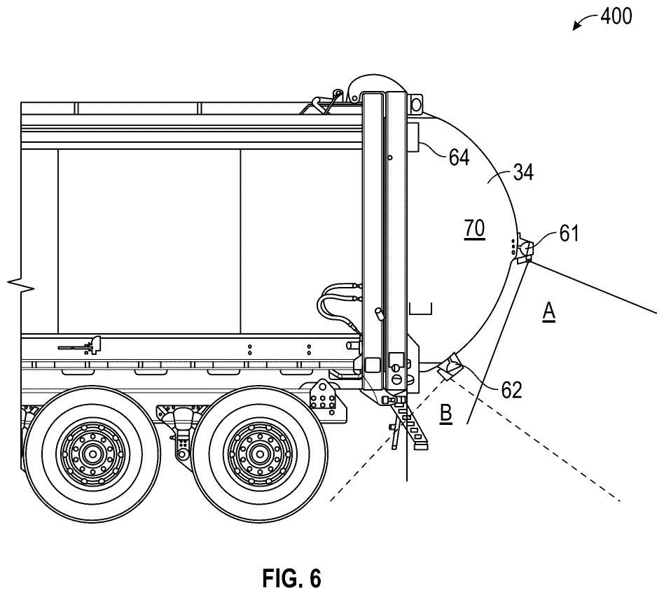

The backup camera system 400 may include one or more components of the control system 100 described above. The backup camera system 400 includes sensors 126 and/or components of the vision system 128 configured to capture images of the region surrounding the rear of the refuse vehicle 10. As shown in FIGS. 6 and 8-10, the backup camera system 400 includes at least a first camera 61 and a second camera 62. In the illustrated embodiments, the cameras 61, 62 are rear-facing (e.g., pointing generally parallel to a direction opposite of the cab 16 of the vehicle 10) and directed toward a target area behind the body 14 of the vehicle 10. That is, the cameras 61, 62 are arranged so that a field of view defined by the cameras 61, 62 includes a target area where the vehicle 10 may enter when travelling in a reverse direction (e.g., operating in a reverse mode). In other embodiments, the cameras 61, 62 may be 360 degree view cameras configured to adjust or focus on a rearward view in response to a reverse operation.

As shown in FIGS. 6 and 8-10, the cameras 61, 62 are integrated into or coupled to the tailgate 34. For example, the cameras 61, 62 may be mounted to and/or integrated into or installed on the tailgate 34 of the vehicle 10. In some embodiments, the first camera 61 is coupled to the surface of the tailgate 34 at a first location above a second location of the second camera 62 (e.g., the first camera 61 may be positioned proximate a center of the tailgate 34 and the second camera may be positioned proximate a bottom of the tailgate 34). In this way, the first camera 61 is configured to capture an image of a first field of view A visible by the first camera 61 that includes a region at least partially above a second field of view B visible by the second camera 62. As shown in FIGS. 6 and 8-10, the field of view of the cameras 61, 62 are represented by dotted lines (indicating a powered off camera, a camera not currently capturing an image, etc.), solid lines (indicating a powered on camera, a camera currently capturing an image, etc.), and dot-dashed lines (indicating an area of overlap of one or more field of view of two active cameras or an active camera and an inactive camera).

In some embodiments, the backup camera system 400 may include additional sensors 126 and/or components of the vision system 128 (e.g., additional cameras, ultrasonic sensors, proximity sensors, infrared sensors, and the like) coupled to an exterior of other portions of the vehicle 10. For example, additional cameras may be coupled to left or right rear side panels 32 of the body 14, portions of the body 14 that allow the cameras/sensors to be directed towards the rear or sides of the vehicle 10, etc. In some embodiments, the cameras 61, 62 are in the form of a DSLR camera, a CCD camera, a time of flight camera, or any other equivalent camera capable of capturing an image of a target area. Regardless of the specific configuration of the vehicle 10 and/or the mounting location of the cameras 61, 62, the cameras 61, 62 and/or additional sensors 126 or components of the vision system 128 are coupled to the vehicle 10 so that that field of view defined by the respective device includes the target area where the refuse vehicle 10 is expected to travel when in a reverse operation.

The backup camera system 400 may also include sensors 126 configured to measure a position of the tailgate 34. For example, the backup camera system 400 may include a first sensor 64 such as an inclinometer coupled to the tailgate 34, a tailgate actuator 24, or the like to determine an angle at which the tailgate 34 is positioned. The controller 102 may receive a signal from the first sensor 64 and correlate the signal to a position of the tailgate 34. For example, a reading of the inclinometer may represent that the tailgate 34 is in a closed position 70 (e.g., where the tailgate 34 is fully lowered and seals the rear portion of the refuse compartment 30). In other embodiments where a sensor 126 is not configured to measure a position of the tailgate 34, the controller 102 may be configured to detect a position of the tailgate 34 by other processes or via other signals. For example, the controller 102 may receive a signal indicating that the tailgate actuator 24 is in operation. The controller 102 may start a timer in response to the activation of the tailgate actuator 24 operating. The controller 102 may be configured to correlate a time of activation of the tailgate actuator 24 to a position, angle, or degree of openness of the tailgate 34. Other similar methods of determining the position of the tailgate 34 as would be apparent to a person of ordinary skill in the art are contemplated by and within the scope of this disclosure.

The camera selection system 399 (and/or the backup camera system 400, the arm/side camera system 410, the hopper camera system 420, etc.) may also include one or more components of the HMI 130 such as a display (e.g., a screen, monitor, or the like positioned within the cab 16). The controller 102 and/or the respective systems 399, 400, 410, 420 are in communication with the display, and the display is in communication with the cameras of the systems 399, 400, 410, 420 (e.g., cameras 61, 62). For example, the display is configured to display images captured by the cameras 61, 62. As shown in FIG. 6, when the tailgate 34 is in a closed position 70, the first camera 61 may be configured to be active/capture images when the vehicle 10 is in a reverse operation, while the second camera 62 located below the first camera 61 may be configured to be off and not capture images.

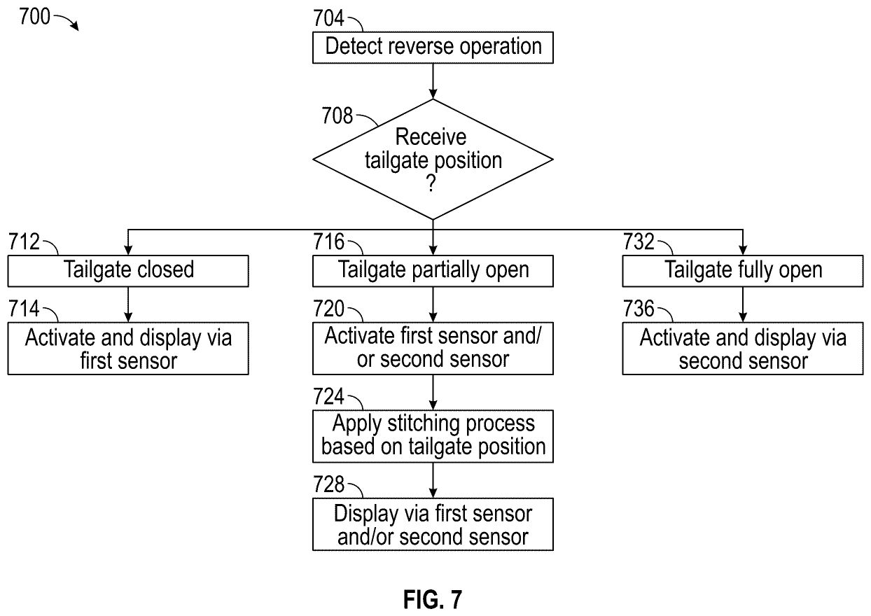

Turning to FIG. 7, a flowchart showing example steps of a method 700 of operation of the backup camera system 400 disclosed herein is shown. In other embodiments, the steps may be rearranged in various order, may be repeated, may be combined with other steps, may include additional or intervening steps, or the like. As shown in FIG. 7, step 704 includes detecting a reverse operation. The controller 102 may receive a signal indicating that the vehicle 10 is preparing or is configured to travel in a reverse direction. For example, the signal may be received when the vehicle 10 is placed in a reverse gear. When the controller 102 detects a reverse operation of the vehicle 10, the controller 102 may activate one or more cameras of the backup camera system 400. The controller 102 may selectively activate one or more cameras based on a position of the tailgate 34.

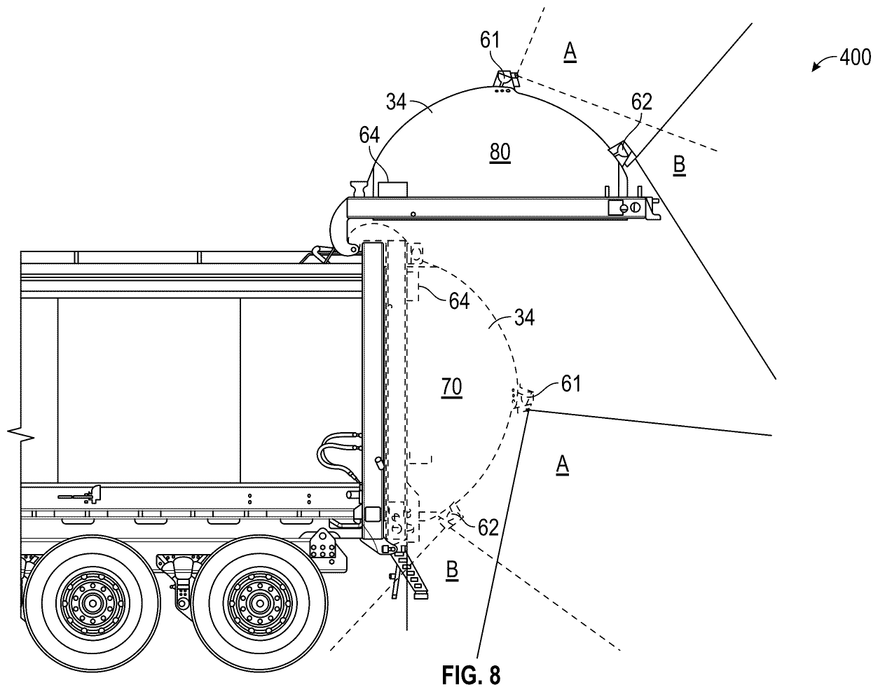

Step 708 includes, receiving, by the controller 102, an indication of a position of the tailgate 34. For example, as shown in FIGS. 8-10, the tailgate 34 may be in a closed position 70, a fully open position 80, or at a partially open position between the fully open position 80 and the closed position 70 (e.g., a first partially open position 75, a second partially open position 77). The tailgate 34 position may determine or define a position of the field of view of the respective cameras (e.g., the first field of view A of the first camera 61, the second field of view B of the second camera 62). Specifically, the field of view of the cameras 61, 62 may only be centered, focused, or otherwise capture the target area behind the vehicle 10 where the vehicle 10 may travel when in reverse when the tailgate 34 is in a certain position. As shown in FIG. 6, when the tailgate 34 is in a closed position, the second field of view B of the second camera 62 is substantially directed towards the ground and/or below the vehicle 10 and may not provide sufficient coverage of the target area behind the vehicle 10 (e.g., to assist an operator in reversing the vehicle 10). Similarly, as shown in FIG. 8, when the tailgate 34 is an a fully open position 80, the first field of view A of the first camera 61 may be substantially directed upward and/or above the rear of the vehicle 10 such that the first field of view A also may not provide sufficient coverage of the target area behind the vehicle 10 (e.g., to assist an operator in reversing the vehicle 10). Accordingly, as shown in FIG. 7 and described herein, the controller 102 and/or the backup camera system 400 may selectively activate or deactivate one or more of the cameras 61, 62 based on the position of the tailgate 34 in order to maintain a fixed image centered, directed, or otherwise focused on the target area behind the vehicle 10.

For example, at step 712, the controller 102 may detect that the tailgate 34 is in the fully closed position 70. While the tailgate 34 is in the fully closed position 70 and the vehicle 10 is in the reverse operation, the controller 102 and/or the backup camera system 400 may activate the first camera 61 and display the first field of view A, which may be focused on the target area behind the vehicle 10. Additionally, the second camera 62 may remain inactive or off while the tailgate 34 is in the fully closed position 70. Accordingly, at step 714, the first camera 61 may be active and display an image of the surroundings behind the vehicle 10 (e.g., to a display in the cab 16 such that an operator may navigate in reverse while viewing the target area behind the vehicle 10 in the reverse path of the vehicle 10).

Focusing on FIG. 7 and FIG. 8, the controller 102 may also detect that the tailgate 34 is in the fully open position 80. As shown in steps 732 and steps 736, while the tailgate 34 is in the fully open position 80 and the vehicle 10 is in the reverse operation, the controller 102 and/or the backup camera system 400 may deactivate the first camera 61 and activate the second camera 62 to display the second field of view B, which may be focused on the target area behind the vehicle 10. Accordingly, the second camera 62 may be active and display an image of the surroundings behind the vehicle 10 (e.g., to a display in the cab 16 such that an operator may navigate in reverse while viewing the target area behind the vehicle 10 in the reverse path of the vehicle 10).

The controller 102 and the backup camera system 400 are also configured to maintain a focused, directed, etc. view of the surroundings of the rear of the vehicle 10 while the tailgate 34 is located at a partially open position (e.g., neither fully closed nor fully open) between the closed position 70 and the fully open position 80. In this way, while the vehicle 10 is in a reverse operation, the tailgate 34 may be opened or closed, and during the process of opening or closing the tailgate 34, the image/display of the surroundings behind the vehicle 10 may be uninterrupted, may not change, or may otherwise remain focused on a region behind the vehicle 10 sufficient to allow an operator to navigate the vehicle 10 in a reverse direction.

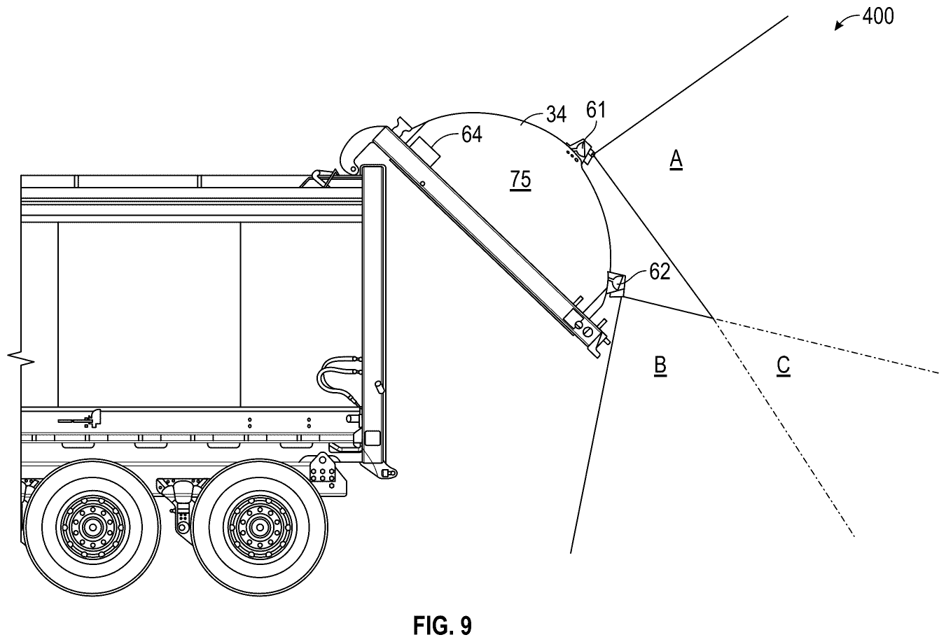

For example, at step 716, the controller 102 and/or the backup camera system 400 may determine that the tailgate 34 is in a partially open position (e.g., the first partially open position 75). As shown in FIG. 9, at a partially open position, the first field of view A of the first camera 61 may capture a first portion (but not all) and the second field of view B of the second camera 62 may capture a second portion (but not all) of the target region behind the vehicle 10. Further, the cameras 61, 62 may share an overlapping field of view C directed at the target region behind the vehicle 10. As shown in FIG. 9, by selectively activating both the first camera 61 and the second camera 62 while the tailgate 34 is in the first partially open position 75, the controller 102 and/or the backup camera system 400 may obtain an image of the target view behind the vehicle 10 unable to be obtained by only one of the first camera 61 or the second camera 62 alone. Accordingly, at step 720, while the tailgate 34 is in the partially open position, the controller 102 and/or the backup camera system 400 may activate both the first camera 61 and the second camera 62.

Further, the camera selection system 399, the backup camera system 400, the arm/side camera system 410, the hopper camera system 420, the controller 102, and/or the control system 100 may include one or more circuits, algorithms, or image processing systems configured to generate a combined image from the views captured by one or more of the camera systems/cameras (e.g., the first camera 61 and the second camera 62). At steps 724 and 728, the controller 102, the backup camera system 400, and/or the control system 100 are configured to combine, selectively view/display, or otherwise adjust the captured images in order uniformly/constantly display the target region behind the vehicle 10. For example, the memory 108 may contain instructions thereon configured to perform one or more of feature matching, photogrammetry, image stitching, image transformation, panoramic image combination, image focusing, or like processes to combine the image of the first view point A and the image of the second view point B in the overlapping field of view C in order to generate and display a third image to display showing the target area behind the vehicle 10. As the angle of the tailgate 34 changes in the partially open position, the controller 102 and/or the backup camera system 400 may be configured to selectively adjust the feature matching, photogrammetry, imagine stitching, or like process such that the field of view of the third image maintains the same. For example, as the tailgate 34 becomes more and more open and less of the first field of view A of the first camera 61 covers the target area behind the vehicle 10, the controller 102 and/or the backup camera system 400 may adjust the image stitching process to utilize more of the second field of view B of the second camera 62 when generating the third image. Accordingly, the display may be configured to receive an image via the backup camera system 400 that remains focused, centered, or otherwise directed to a set section or viewpoint of the target area behind the vehicle 10 regardless of the position of the tailgate 34 and while the tailgate 34 is in motion, open, closed, etc.

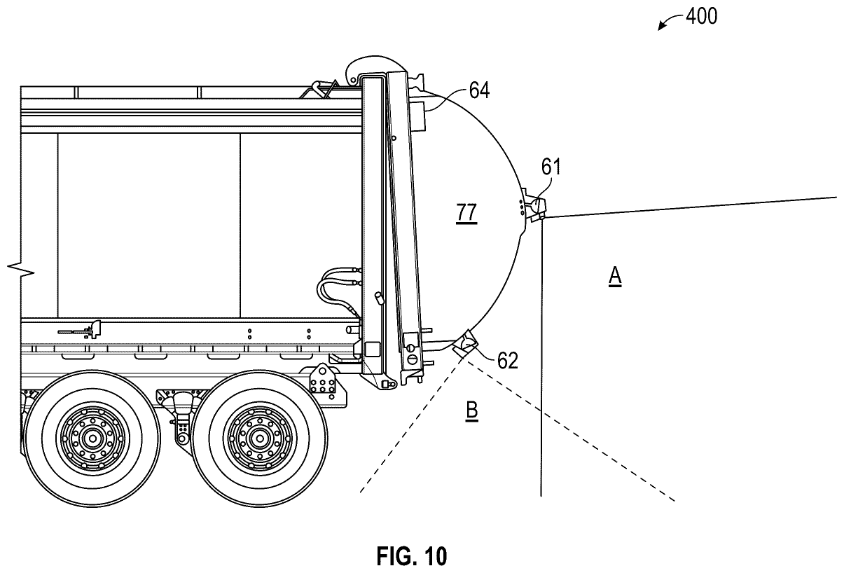

Turning to FIG. 10, in some embodiments, the tailgate 34 may be positioned at a partially opened position (e.g., a second partially open position 77) wherein the target area behind the vehicle 10 is sufficiently covered by the view of only one camera 61, 62 even though a portion of the target region may also be in an overlapping field of view. For example, as shown in FIG. 10, when the tailgate 34 is very slightly opened (e.g., opened by about 5-10 degrees), the first field of view A of the first camera 61 may only shift slightly and may still cover the entire target area showing the reverse travel path of the vehicle 10, even if a small portion of the second field of view B of the second camera 62 also overlaps with the target area. In some embodiments, at positions such as the second partially open position 77, the controller 102 and/or the camera selection system 399, the backup camera system 400, etc. may activate only one camera (e.g., the first camera 61 in FIG. 10) even though the tailgate 34 is neither closed nor fully open. Instead of applying an image stitching process, the controller 102 and/or the backup camera system 400 may selectively display a portion of the field of view (e.g., the first field of view A) that sufficiently covers the target area. For example, the controller 102 and/or the backup camera system 400 may crop or focus the view of the first camera 61 to some or all of the first field of view A and may omit other portions such as a portion that is directed upwards/above the target area behind the vehicle 10.

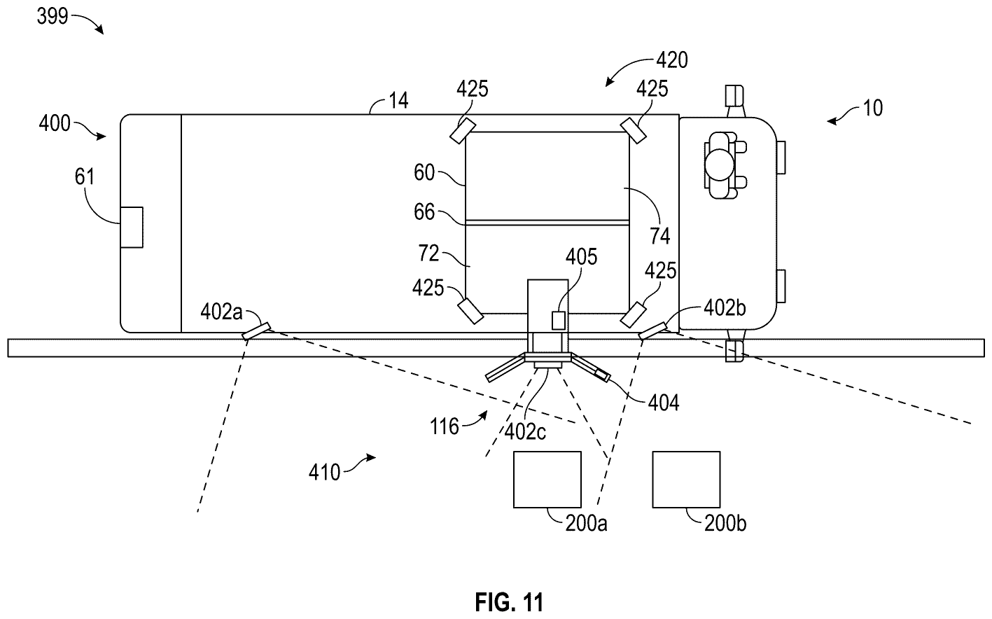

Turning to FIG. 11, the camera selection system 399 is shown provided on a side-loading refuse vehicle 10. The refuse vehicle 10 includes the lift apparatus 116 on a curbside of the refuse vehicle 10. The lift apparatus 116 may have the form of a robotic arm having multiple articulable joints and a claw or grabber, a tracked lift apparatus including a grabber, or any combination thereof. As shown in FIG. 11, the camera selection system 399 includes multiple camera systems (e.g., the backup camera system 400, the arm/side camera system 410, and the hopper camera system 420) that may each have multiple cameras. Like the cameras of the backup camera system 400, the additional camera systems may include cameras in the form of a DSLR camera, a CCD camera, a time of flight camera, a 360-degree view camera, or any other equivalent camera capable of capturing an image of a target area. For example, the arm/side camera system 410 includes cameras shown as first camera 402a, second camera 402b, and third camera 402c. While the cameras 402 are shown disposed on a curb-side of the refuse vehicle 10, the cameras 402 may be positioned on a front of the refuse vehicle 10, a rear, on different corners, at different heights, at different orientations, on a street-side of the refuse vehicle 10, etc. More generally, the cameras 402 are directed outwards such that refuse containers 200 (e.g., first refuse container 200a and second refuse container 200b) are within a field of view of the cameras 402. The cameras 402 may obtain image data of the refuse containers 200 as the refuse vehicle 10 arrives at or approaches the refuse containers 200. As shown in FIG. 11, the third camera 402c may be disposed on a claw or portion of the lift apparatus 116.

The refuse vehicle 10 may be a multi-chambered vehicle including at least two refuse compartments, each for a different type of refuse, or may be a single-chambered vehicle including a single refuse compartment for one type of refuse. For example, the refuse vehicle 10 may be a garbage truck or a recycling truck with a single corresponding refuse compartment for garbage or recycling. The refuse vehicle 10 can also be a combination of a garbage truck and a recycling truck so that the refuse vehicle 10 can collect both garbage and recycling. If the refuse vehicle 10 is configured to collect both garbage and recycling (e.g., different types of refuse), the refuse vehicle 10 may include a hopper 60 having two hopper openings for the different types of refuse, shown in FIG. 11 as first hopper opening 72 and second hopper opening 74. Refuse of a first type (e.g., garbage) may be emptied into the first hopper opening 72 and refuse of a second type (e.g., recycling) may be emptied into the second hopper opening 74. The lift apparatus 116 may be configured to selectively transport and empty the refuse containers 200 into one of the first hopper opening 72 or the second hopper opening 74. In some embodiments, the hopper 60 has a partition that is transitionable between different positions or states in order to allow access to one of the first hopper opening 72 or the second hopper opening 74, and to limit access to another of the first hopper opening 72 or the second hopper opening 74. In this way, the lift apparatus 116 and the hopper 60 may be operated to empty refuse into one of a first refuse compartment or a second refuse compartment.

The arm/side camera system 410 of the camera selection system 399 may be configured to capture an image showing the area proximate to the side of the refuse vehicle 10 and/or a view of an area within the gripping range of the lift apparatus 116 of the refuse vehicle 10. The camera selection system 399 is configured to assign a priority value to an image/view from the arm/side camera system 410 based on an operating condition of the refuse vehicle 10 or an event associated with the refuse vehicle 10. The camera selection system 399 and the arm/side camera system 410 may be configured to display an image of the area proximate to the side of the refuse vehicle 10 after comparing the priority value of the arm/side camera system 410 and that of another camera system. For example, the camera selection system 399 may display a view of the area proximate to the side of the refuse vehicle 10 and/or a view of an area within the gripping range of the lift apparatus 116 in response to/upon detecting operation of the lift apparatus 116, which may correspond to a high priority value of the arm/side camera system 410. For example, the lift apparatus 116 may be controlled by a joystick, controller, keyboard, or the like. Upon detecting movement of the joystick, controller, keyboard and/or signals indicating operation of the lift apparatus 116, the camera selection system 399 may automatically or semi-autonomously assign a view from the arm/side camera system 410 with a high priority value (e.g., an 8 on a 10 point scale or other numerical ranking, etc.). The camera selection system 399 may compare the priority value to that of other systems, and upon determining that the priority value is higher than, equal to that of other systems, or at a sufficient priority threshold, select and display a view from the arm/side camera system 410. For example, an image of the area beside the refuse vehicle 10 may be generated and presented to an operator via a display before the lift apparatus 116 engages/grabs a refuse container 200 (e.g., based on the camera selection system 399 receiving a signal indicating the lift apparatus 116 has identified an RFID tag of a refuse container 200). Once the lift apparatus 116 engages/grabs a refuse container 200 and begins lifting the refuse container 200, a camera/sensor on the lift apparatus 116 may become obscured/obstructed by the refuse container 200. However, the camera selection system 399 may stitch together images from one or more cameras/sensors of the arm/side camera system 410 to continue to display an image of the area beside the refuse vehicle 10 regardless of the position of the lift apparatus 116 by selectively capturing images via a plurality of cameras of the vision system 128. Alternatively, the camera selection system 399 may shift views to a single camera located on the side of the refuse vehicle 10 and display a view at the position of that camera/sensor.

Like the backup camera system 400 discussed above, the arm/side camera system 410 may include additional sensors 126 and/or components of the vision system 128 configured to capture detect information of the region surrounding the side of the refuse vehicle 10. For example, as shown in FIG. 11, the arm/side camera system 410 may include a radio frequency identification (RFID) detector 404 (e.g., an RFID reader, an RFID transponder, etc.) that is configured to wirelessly transmit energy to proximate RFID tags. The RFID detector 404 may monitor responses that are received from nearby RFID tags. In particular, the refuse containers 200 may include RFID tags that are configured to provide a response signal to the RFID detector 404. In some embodiments, up receiving a signal from an RFID tag of a refuse container 200, the camera selection system 399 may autonomously or semi-autonomously select and display a view from the arm/side camera system 410 to assist the operator in locating and/or lifting the refuse container.

Additionally, the arm/side camera system 410 may include a position indicator 405. For example, the position indicator 405 may include a proximity sensor, an inclinometer, or a position feedback circuit sending a signal to the camera selection system 399 indicative of a height, lift angle, or position of the lift apparatus 116. In this way, the camera selection system 399 may determine a priority to assign a view from the arm/side camera system 410 and the hopper camera system 420 based on the position of the lift apparatus 116. For example, while the lift apparatus 116 is lowered and no refuse container is being loaded into the hopper 60, the camera selection system 399 may prioritize displaying a view from the arm/side camera system 410 (e.g., assign a low priority value to a view from the hopper camera system 420). Accordingly, the camera selection system 399 may display a view from the hopper camera system 420 on only a small portion of the display relative to other views or may not display a view from the hopper camera system 420 on the display.

However, the position indicator 405 may indicate to the camera selection system 399 that priority should be given to displaying a view from the hopper camera system 420 or that the priority values of the arm/side camera system 410 and the hopper camera system 420 should be adjusted/updated. For example, a proximity sensor may measure the distance between the lift apparatus 116 and the ground and/or a distance between the lift apparatus 116 and the hopper 60. Upon detecting that the lift apparatus 116 is approaching the hopper 60 or that the lift apparatus 116 is greater than a certain distance from the ground, the camera selection system 399 may determine that a refuse container 200 will soon be emptied into the hopper 60, and thus the operator would benefit if a view from the hopper camera system 420 were received at the display (e.g., assign the hopper camera system 420 higher priority and assign the arm/side camera system 410 lower priority). In this way, the camera selection system 399 may autonomously or semi-autonomously prioritize the view from the hopper camera system 420 while refuse is being loaded into the hopper 60. In other examples, an inclinometer may detect a certain angle associated with the lift apparatus 116 approaching the hopper 60 and similarly signal the camera selection system 399 to prioritize a view from the hopper camera system 420. In further examples, the camera selection system 399 may detect the start of an operation of the lift apparatus 116 and may start a timer in response to the activation of the lift apparatus 116. The camera selection system 399 may be configured to correlate a time of activation of lift apparatus 116 to a position, angle, or height of the lift apparatus 116. When the timer is below a certain threshold or the lift apparatus 116 is below a designated height, the camera selection system 399 may prioritize presenting a view of the arm/side camera system 410. In contrast, when the timer has run long enough or the lift apparatus 116 is above a designated height, the camera selection system 399 may prioritize displaying a view of the hopper camera system 420.

Still referring to FIG. 11, the camera selection system 399 includes an illustrative hopper camera system 420. The hopper camera system 420 may be configured to capture an image showing the area proximate to the top of the refuse vehicle 10 and/or a view of an area within/above the hopper 60 of the refuse vehicle 10. The hopper camera system 420 may include sensors 126 and/or components of the vision system 128. For example, as shown in FIG. 11, the hopper camera system 420 may include at least one or more cameras 425 disposed about the hopper 60 and/or the top of the refuse vehicle 10. As discussed above, the camera selection system 399 and the hopper camera system 420 are configured to display an image of the area proximate to the top of the refuse vehicle 10 and/or a view of an area within/above the hopper 60 in response to/upon detecting that the operation of the lift apparatus 116 has reached a certain height (e.g., that the lift apparatus 116 is in the process of emptying a refuse container 200 into the hopper 60, the lift apparatus 116 is approaching the hopper 60, etc.). In this way, the camera selection system 399 provides an operator with a view of the hopper 60 to ensure a clear path/enough space is available to continue the refuse collection operation. Further, the camera selection system 399 may autonomously or semi-autonomously select and/or prioritize the view of the hopper 60 to assist the operator in completing the refuse collection operation without requiring additional operator input. In some embodiments, additional sensors 126 (e.g., proximity sensors, optical sensors, etc.) may be disposed atop the refuse vehicle 10 and/or about the hopper 60. These sensors 126 may detect that the lift apparatus 116 is approaching the hopper 60 and provide a signal to the camera selection system 399. Similarly, these sensors 126 may detect refuse entering the hopper 60 or falling into the hopper 60 and send a signal to the camera selection system 399. Upon receiving such signals, the camera selection system 399 may prioritize displaying a view from the hopper camera system 420 or adjust other priority values for target views.

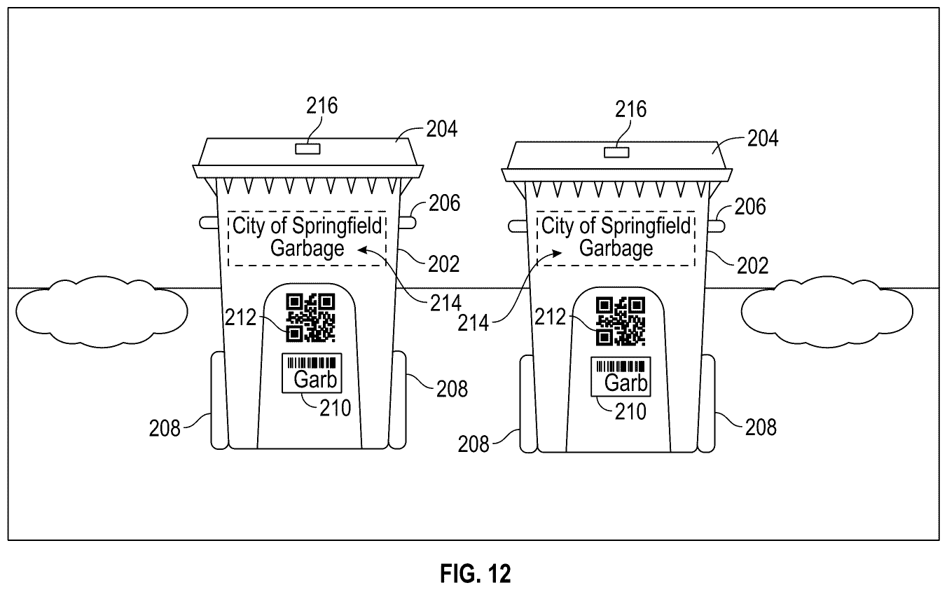

Turning to FIG. 12, a perspective view from the arm/side camera system 410 is shown, according to an example embodiment. As shown in FIG. 12, a view from the arm/side camera system 410 may include one or more refuse containers 200. At other times, a view from the arm/side camera system 410 may include no refuse containers 200. The camera selection system 399 may be configured to assign a higher priority value to a view from the arm/side camera system 410 when objects of interest (e.g., refuse containers 200) are visible within the field of view of the cameras (e.g., cameras 402) or detected by sensors 126.

As shown in FIG. 12, the refuse containers 200 include a body 202 that defines a compartment or inner volume for refuse, a pair of wheels 208, handles 206, a lid 204, and printed text 214 or decals. The refuse container 200 may also include an RFID tag 216. The refuse container 200 may also include a quick response (QR) code 212. The refuse container 200 may also include a barcode 210. In some embodiments, one or more portions of the refuse container 200 have different colors to indicate whether the refuse container 200 contains garbage or recyclable materials. The camera selection system 399 may obtain the image data from the cameras 402 of the refuse containers 200 that are within the field of view of the cameras 402. The camera selection system 399 may identify one or more features of the refuse container 200 to increase or decrease the priority of the view of the arm/side camera system 410. For example, if the refuse vehicle 10 is only equipped to collect garbage rather than recycling, the camera selection system 399 can be implemented to identify, based on the size, shape, and/or color, whether the refuse container 200 is a recycling container or a garbage can. Accordingly, the camera selection system 399 may assign a low priority value to a view that only contains recycling containers and a higher priority value to a view that includes garbage cans.

The camera selection system 399 may be configured to implement any machine learning, neural network, or artificial intelligence to assign a priority value to a given view from a camera system. For example, the controller 102 may implement an image analysis by performing any of the functionality as described in greater detail in U.S. Pat. No. 11,527,072, filed Apr. 23, 2020, the entire disclosure of which is incorporated by reference herein, and assign priority values based on the results of the image analysis (e.g., high priority for refuse present, low priority for no refuse present). The image analysis may be implemented locally on the controller 102 or remotely by the remote computing system 134.

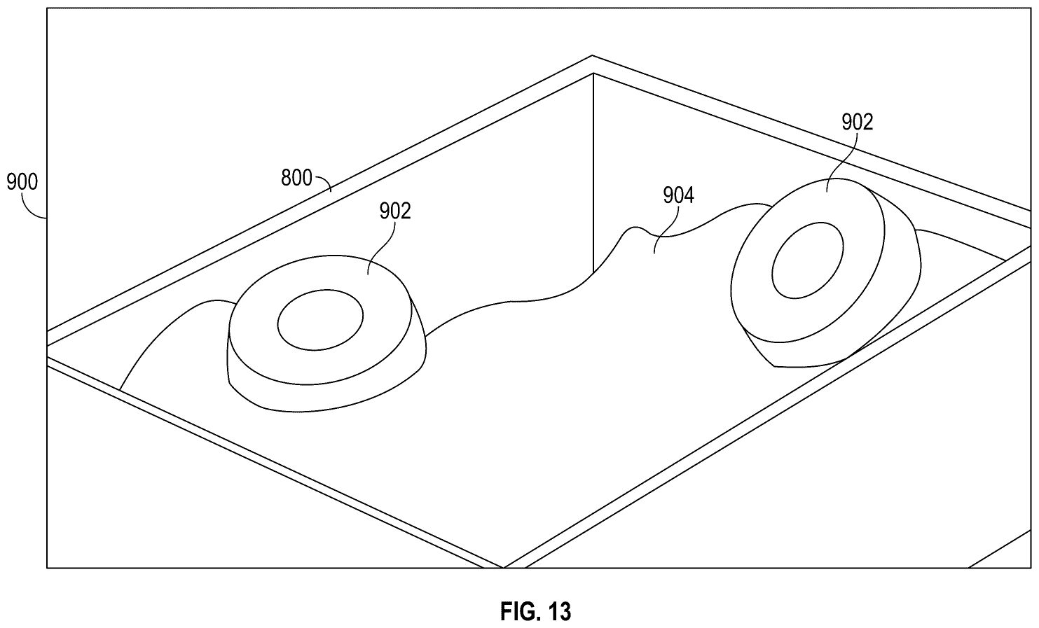

Turning to FIG. 13, a diagram illustrates image data 900 that may be obtained by the cameras 425 of the hopper camera system 420. The image data 900 includes a view of an interior of the hopper 60 and/or refuse compartment 30 (for example, illustrating refuse 904 and tires 902). The image data 900 can be used (e.g., analyzed) by the camera selection system 399 to determine, assign, update, or otherwise associate a priority value with a view from the hopper camera system 420 (e.g., a view into the hopper 60). For example, the image data 900 obtained from the cameras 425 of the hopper camera system 420 may indicate that the hopper 60 is nearly full or full. Accordingly, the camera selection system 399 may assign the hopper camera system 420 a high priority to prevent an operator from overloading the hopper 60.

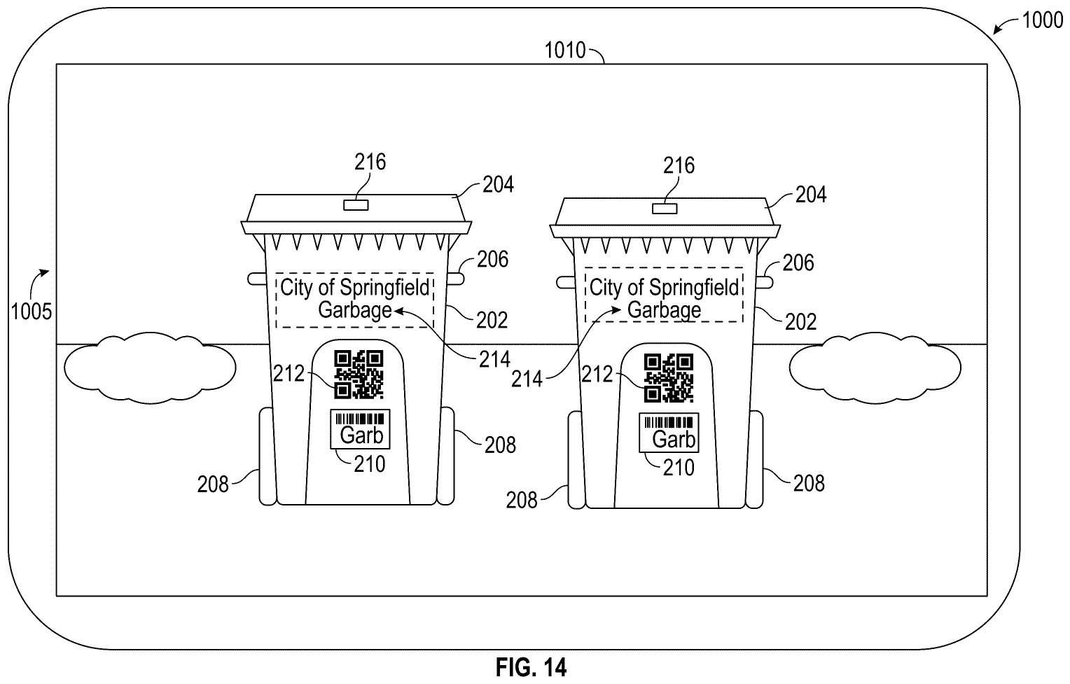

FIG. 14 is an illustrative GUI 1000 of the refuse vehicle 10 equipped with the camera selection system 399 showing an example view from an arm/side camera system 410, according to an exemplary embodiment. As discussed above, the GUI 1000 may be located in the cab 16 of the refuse vehicle 10, may be a display associated with a mobile device communicatively coupled to the refuse vehicle 10, may be an LCD screen, touch screen, or other display (e.g., any HMI 130) of the refuse vehicle 10 or the like. The GUI 1000 may comprise one or more screens 1005 that may display one or more images on one or more sections of the screens 1005. For example, in FIG. 14, the GUI 1000 having one screen 1005 is shown, the one screen 1005 showing data 1010 associated with the arm/side camera system 410 on the entire screen 1005. In this way, the screen 1005 is configured to display an image on one section of the screen 1005 (e.g., the entire screen). As discussed herein, the camera selection system 399 may be configured to display multiple images/video feeds simultaneously on various sections of the one or more screens 1005. For example, the screen 1005 may display three camera views in three rectangular sections, may display six different camera views on six sections of the same size, may display six different camera views on sections of varying sizes, or the like. The camera selection system 399 may determine and select the configuration of the screen 1005, the size of each section, the number of camera/views and sections display based on the priority values assigned to each respective view from the various camera systems and/or sensors (e.g., systems 128, 400, 410, 420 and/or sensors 61, 62, 126, etc.).

As shown in FIG. 14, the camera selection system 399 presents a selected a view from the arm/side camera system 410 on the GUI 1000 and is not displaying views from the backup camera system 400 or the hopper camera system 420. In this way, the camera selection system 399 may assign a priority to a respective camera system such that only a single view will be displayed. For example, as shown in FIG. 14, the arm/side camera system 410 displays a view including multiple refuse containers 200. Accordingly, while collecting refuse, the camera selection system 410 may prioritize a view from the arm/side collection system 410. The increase in the priority may be in response to detection of refuse containers 200 adjacent to the vehicle 10, receiving a signal indicating that an operator has activated/touched a joystick/keyboard/controls of the lift apparatus 116, receiving an RFID signal detected by the lift apparatus 116, etc.

Other events may result in the camera selection system 399 giving high priority to the other camera systems such that views from those systems are displayed on the entire screen 1005. For example, if no signal from the lift apparatus 116 is detected (e.g., the lift apparatus 116 is not in use), the hopper camera system 420 detects no obstructions in the hopper (e.g., the hopper 60 is empty), and the camera selection system 399 receives a signal indicating that the vehicle 10 is in a reverse driving mode or in a reverse operation, the camera selection system 399 may assign a high priority to the backup camera system 400 such that the entire screen 1005 displays a view from the backup camera system 400. In some embodiments, the backup camera system 400 may always be given the highest priority (e.g., at least one portion of the display provides a view from the backup camera system 400) in response to the vehicle 10 entering a reverse mode.

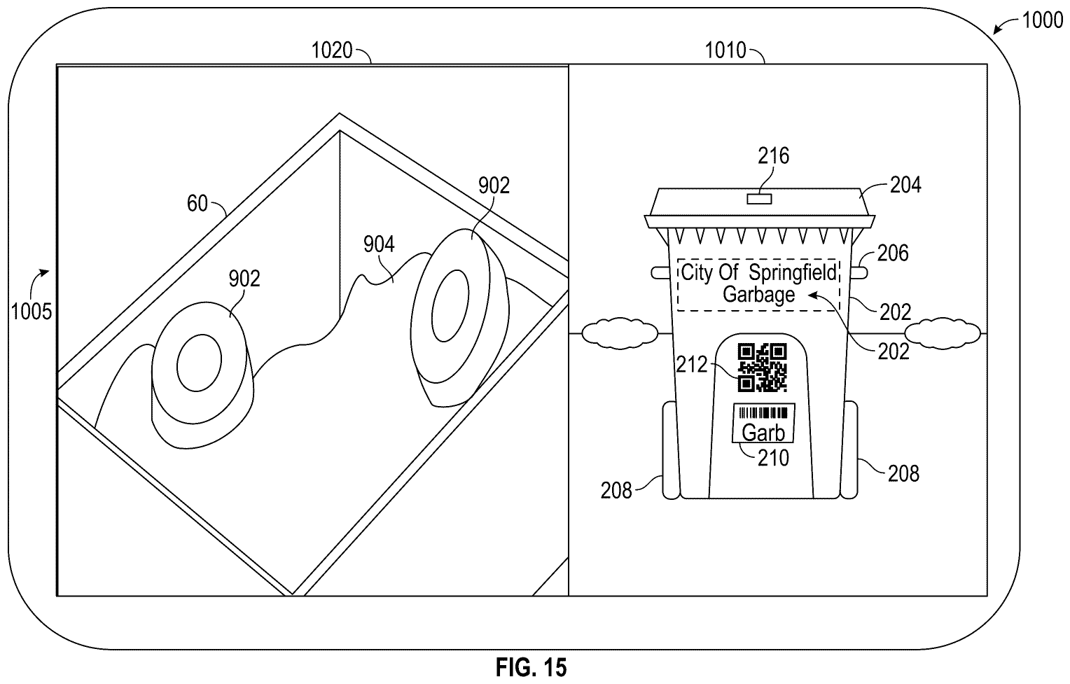

As shown in FIG. 15, the camera selection system 399 may assign priority values to two or more camera systems such that views from the two or more camera systems are displayed on at least a portion of the screen 1005. For example, the GUI 1000 in FIG. 15 includes data 1020 from the hopper camera system 420 on a section of the screen 1005 roughly twice as large as the section of the screen 1005 displaying data 1010 from the arm/side camera system 410. In some embodiments, the camera selection system 399 may assign respective priority values indicating that two or more views should be displayed, but that one or more views should be displayed larger/more prominently on one or more screens 1005. For example, the lift apparatus 116 may reach a certain height threshold (e.g., as determined from a signal of the position indicator 405), indicating that refuse will be emptied into the hopper 60. Once the lift apparatus 116 reaches the height threshold or refuse begins entering the hopper 60, the camera selection system 399 may assign the hopper camera system 420 a higher priority than the arm/side camera system 410 so that the operator may clearly view the contents of the refuse containers 200 entering the hopper 60. As shown in the transition from FIG. 14 to FIG. 15, as the lift apparatus 116 begins emptying refuse into the hopper 60 (e.g., the lift apparatus 116 has collected one refuse can and has fully lifted the can), the camera selection system 399 delegates the display of data 1010 to a smaller section of the screen 1005 than data 1020 from the hopper camera system 420. In this way, the camera selection system 399 may display multiple images at different sections on one or more screens and may prioritize an image/view such that it some or all of the other camera views are removed/are not displayed. For stitched camera views and 360-degree camera views, the camera selection system 399 may prioritize the areas/regions of interest within the camera's view and display a particular section or cropped view area from one camera system.

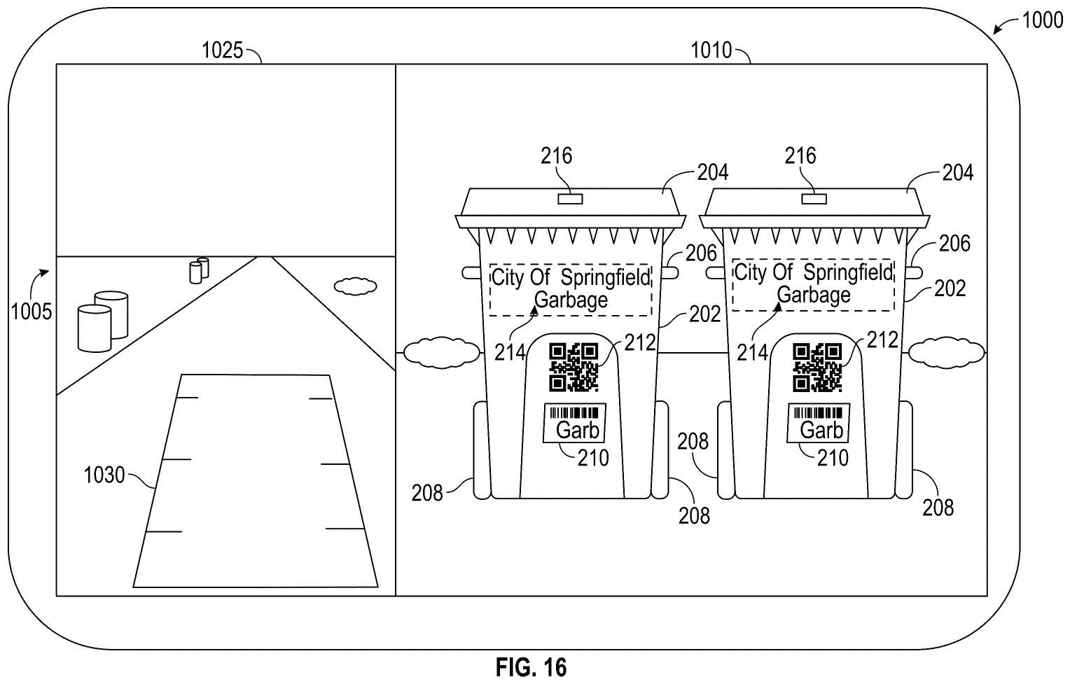

Turning to FIG. 16, an example view from the backup camera system 400 and the arm/side camera system 410 is shown, according to an exemplary embodiment. For example, the vehicle 10 may lower the refuse container 200 and cease the refuse collection action. The arm/side camera system 410 may detect the refuse containers 200, and thus the camera selection system 399 may assign a priority value to the arm/side view. The operator may cause the vehicle 10 to begin a reverse operation or enter a reverse mode, which may cause the camera selection system 399 to give a higher priority to the backup camera system 400 view. As shown in FIG. 16, the higher priority results in the screen 1005 displaying the backup camera system 400 on the largest section. In other embodiments, the camera selection system 399 may select and only display the backup camera view. As shown in FIG. 16, any of the camera systems (e.g., the backup camera system 400, the arm/side camera system 410, and/or the hopper camera system 420) may include one or more graphic overlays 1030 to assist the operator. For example, graphic overlays 1030 may include distance/pathing assistance overlays for the backup camera system 400, identifying text and object recognition overlays for the arm/side camera system 410 or hopper camera system 420, and the like.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

1. A refuse vehicle comprising:
a chassis;
a body coupled to the chassis, the body defining a refuse compartment;
a lift assembly configured to lift a refuse container to dump contents thereof into the refuse compartment;
a display interface;
a plurality of cameras positioned to capture a plurality of different views from the refuse vehicle; and
a controller configured to:
assign priority values to the plurality of different views;
compare the priority values; and
display, on the display interface, at least one of the plurality of different views based on the comparison of the priority values.

2. The refuse vehicle of claim 1, wherein the plurality of cameras include a backup camera positioned to capture a first view of a first area rearward of the refuse vehicle, a lift assembly camera positioned to capture a second view of a second area proximate the lift assembly, and a hopper camera positioned to capture a third view of a hopper area of the refuse compartment.

3. The refuse vehicle of claim 2, wherein the controller is configured to:
display one of the first view, the second view, or the third view on the display interface at a first point in time; and
display two of the first view, the second view, or the third view simultaneously on the display interface at a second point in time.

4. The refuse vehicle of claim 3, wherein the two of the first view, the second view, or the third view at the second point in time are different sizes on the display interface based on the priority values.

5. The refuse vehicle of claim 2, wherein the controller is configured to determine the priority values based on a vehicle event or operation.

6. The refuse vehicle of claim 5, wherein the vehicle event or operation includes at least one of detection of a refuse container proximate the refuse vehicle or operation of the lift assembly, and wherein the controller is configured to assign a higher priority value to the second view than the first view and the third view in response to the at least one of detection of the refuse container proximate the refuse vehicle or the operation of the lift assembly.

7. The refuse vehicle of claim 6, wherein the vehicle event or operation includes detecting the refuse container proximate the refuse vehicle.

8. The refuse vehicle of claim 6, wherein the operation of the lift assembly includes engaging with the refuse container and lifting the refuse container towards the hopper area, and wherein the controller is configured to:
determine that the lift assembly has lifted the refuse container to a position threshold; and
assign a higher priority value to the third view than the second view in response to the lift assembly reaching the position threshold.

9. The refuse vehicle of claim 8, wherein the controller is configured to transition from only displaying the second view to displaying at least the third view in response to the position threshold being reached.

10. The refuse vehicle of claim 8, wherein the controller is configured to display the second view and the third view in response to the position threshold being reached, the third view being larger than the second view.

11. The refuse vehicle of claim 5, wherein the vehicle event or operation includes a reverse operation of the refuse vehicle, and wherein the controller is configured to assign a higher priority value to the first view than the second view and the third view in response to the reverse operation of the refuse vehicle.

12. A refuse vehicle comprising:
a chassis;
a body coupled to the chassis, the body having a refuse compartment with a hopper area;
a lift assembly configured to lift a refuse container to dump contents thereof into the hopper area;
a display interface;
a lift assembly camera positioned to capture a first view of a lift area proximate the lift assembly;
a hopper camera positioned to capture a second view of the hopper area; and
a controller configured to:
detect at least one of a refuse container proximate the refuse vehicle or operation of the lift assembly;
control the display interface to display the first view;
determine that the lift assembly has lifted the refuse container to a position threshold; and
control the display interface to transition from displaying the first view to displaying at least the second view in response to the position threshold being reached.

13. The refuse vehicle of claim 12, wherein the controller is configured to control the display interface to display the first view and the second view in response to the position threshold being reached.

14. The refuse vehicle of claim 13, wherein the second view is larger than the first view.

15. The refuse vehicle of claim 12, further comprising a backup camera positioned to capture a third view of a reverse area rearward of the refuse vehicle.

16. The refuse vehicle of claim 15, wherein the controller is configured to:
detect that the refuse vehicle is performing a reverse operation; and
control the display interface to display at least the third view.

17. The refuse vehicle of claim 16, wherein the controller is configured to display the first view and the third view in response the reverse operation.

18. The refuse vehicle of claim 17, wherein the third view is larger than the first view.

19. A refuse vehicle system comprising:
a lift assembly camera configured to positioned to capture a first view of a lift area proximate a lift assembly of a refuse vehicle;
a hopper camera configured to be positioned to capture a second view of a hopper area of the refuse vehicle; and
a non-transitory computer-readable medium having instructions stored thereon that, when executed by one or more processors, cause the one or more processors to:
detect at least one of a refuse container proximate the refuse vehicle or operation of the lift assembly;
control a display interface of the refuse vehicle to display the first view;
determine that the lift assembly has lifted the refuse container to a position threshold; and
control the display interface to transition from displaying the first view to displaying at least the second view in response to the position threshold being reached.

20. The refuse vehicle system of claim 19, wherein the controller is configured to control the display interface to display the first view and the second view in response to the position threshold being reached, and wherein the second view is larger than the first view.
